(19) United States
(12) Patent Application Publication
(10) Pub. No.: US 2011/0195651 A1
(43) Pub. Date: Aug. 11, 2011

(54) APPARATUS TO INJECT LIQUID SOLUTION INTO A VEHICLE AIR AIRCULATING SYSTEM

(76) Inventors: Ariel Rancel, Naples, FL (US); John Tiplady, West Eagborough (GB); Eyal Hakim, Boca Raton, FL (US)

(21) Appl. No.: 13/023,474

(22) Filed: Feb. 8, 2011

Related U.S. Application Data
(60) Provisional application No. 61/337,578, filed on Feb. 8, 2010.

(51) Int. Cl. B60H 3/02

(52) U.S. Cl. 454/157

(57) ABSTRACT

A liquid-misting apparatus is described that is installed in the air-handling system of a vehicle. Upon operation by an occupant of the vehicle, the system mists liquid containing a fragrance, deodorant, antibacterial solution, etc. or any combination thereof into the air handling system of the vehicle to improve the comfort and enjoyment of all of the occupants of the vehicle.

### REFERENCE TO RELATED APPLICATIONS

This application claims an invention which was disclosed in Provisional Application No. 61/337,578, filed Feb. 8, 2010, entitled “APPARATUS TO INJECT LIQUID SOLUTION INTO A VEHICLE AIR AIRCULATING SYSTEM”. The benefit under 35 USC §119(e) of the United States provisional application is hereby claimed, and the aforementioned application is hereby incorporated herein by reference.

### ACKNOWLEDGMENT OF GOVERNMENT SUPPORT

Not applicable.

### BACKGROUND OF THE INVENTION

1. Field of the Invention

The invention pertains to the field of vehicle air fresheners. More particularly, the invention pertains to an air freshener for use in a vehicle that employs a solvent fluid containing a fragrance and/or air freshening agent and stored in the vehicle for injection into the vehicle's air conditioning and/or heating system.

2. Description of Related Art

Vehicular air fresheners are well known to the art, and many types are available on the market. Most function acceptably well, but all have a common problem, in that they are cumbersome add-ons that intrude into the already-cramped passenger compartment of the vehicle. They can be easily bumped into and broken or dislodged.

One example of this is published patent application 2009/0250526 by Litten-Brown, et al. That invention requires the installation of a fragrance device containing multiple compartments into the passenger compartment of a vehicle. While it can be used with the vehicle's existing heating/air conditioning system, the placement of the invention near the vents of the vehicle reduces existing space. Although it also contemplates the use of a separate fan for the required air flow, this further increases the space required for its use.

### SUMMARY OF THE INVENTION

In contrast, the existing invention works with the vehicle's existing air-handling system with minimal intrusion. Other than a control switch, no visible presence in the vehicle compartment is required. Loss of space in the vehicle compartment is therefore reduced to an absolute minimum.

### BRIEF DESCRIPTION OF THE DRAWING

FIG. 1 shows an embodiment of the invention installed in a typical vehicle air-handling system.

FIG. 2A shows the component parts for the attachment depicted in FIG. 1.

FIG. 2B shows the top view of the nozzle.

FIG. 3A shows the electrical system connections in a vehicle equipped with a fuse box.

FIG. 3B shows the electrical system connections in a vehicle where an inline fuse is employed.

FIG. 4A shows the liquid connections and liquid-handling components of the apparatus

FIG. 4B shows the electrical connections of the apparatus.

FIG. 5 is a diagram of an example switch installation for the invention in the vehicle passenger compartment.

### DETAILED DESCRIPTION OF THE INVENTION

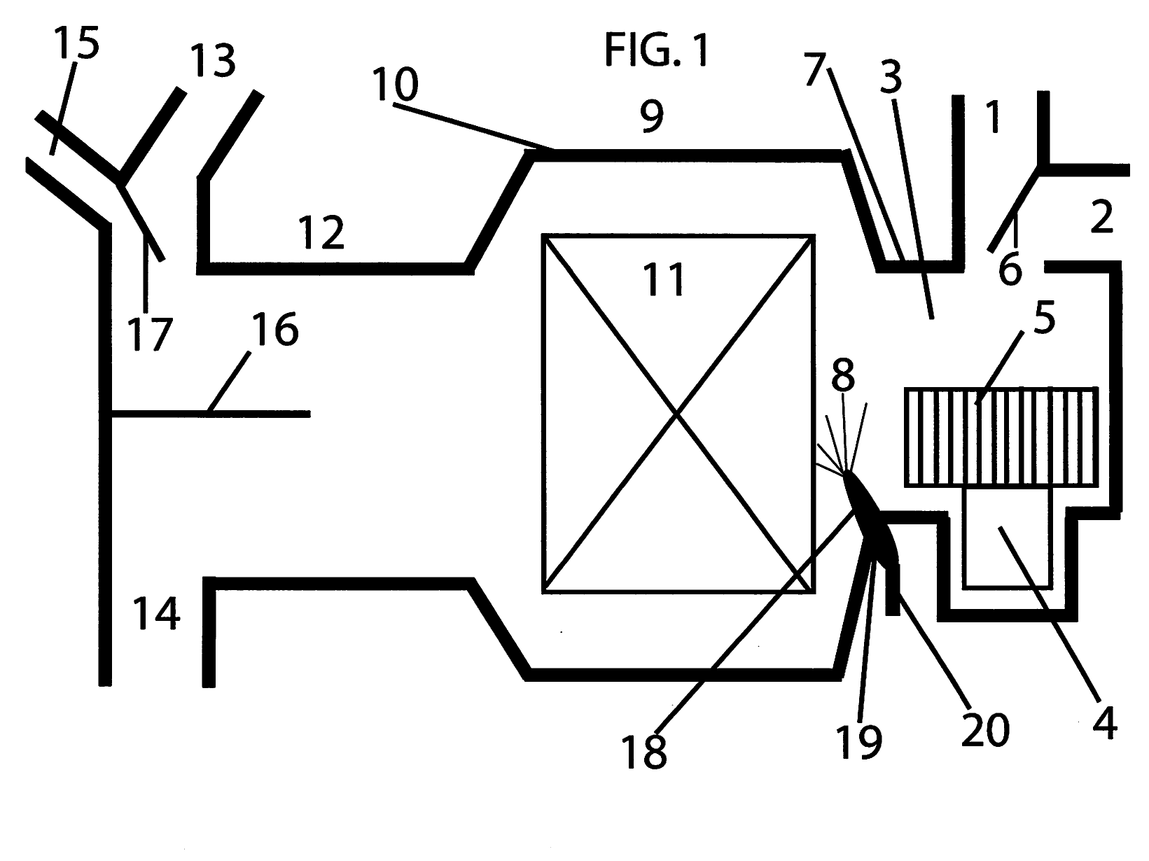

The drawings show an air-handing system for a vehicle and the present invention installed thereto. In FIG. 1. an internal/external air changeover box 3 having an external air intake port 1 and an internal air intake port 2 is provided, and a fan 5 driven by a blower motor 4 is disposed in the box 3, together with an internal/external air changeover door 6 for selecting intake of air conditioning air.

In a next stage connected to thus composed blower unit 7, a cooler unit 9, which incorporates an evaporator 11, is employed as a heat exchanger in a cooler housing 10. The evaporator 11 is an evaporating device connected in a refrigeration cycle to external elements not shown but well-known to those skilled in the art, and acts to deprive the surrounding air of heat.

Air in the system then flows from cooler unit 9 to heater control unit 12. Inside this unit 12, there are a heater core, an air mixing door 16, and vent door 17. By movement of air mixing door 16 and vent door 17, conditioned air (cool air or warm air) is blown out into the passenger compartment in the desired proportions through heat outlet 13, floor outlet 14, and vent outlet 15.

In an embodiment of the invention contained in a thusly-constituted vehicle air-handling system, the nozzle 18 is positioned at the upstream side of the evaporator 11 for directing a liquid spray 8 toward the forward (air intake) side of the evaporator 11.

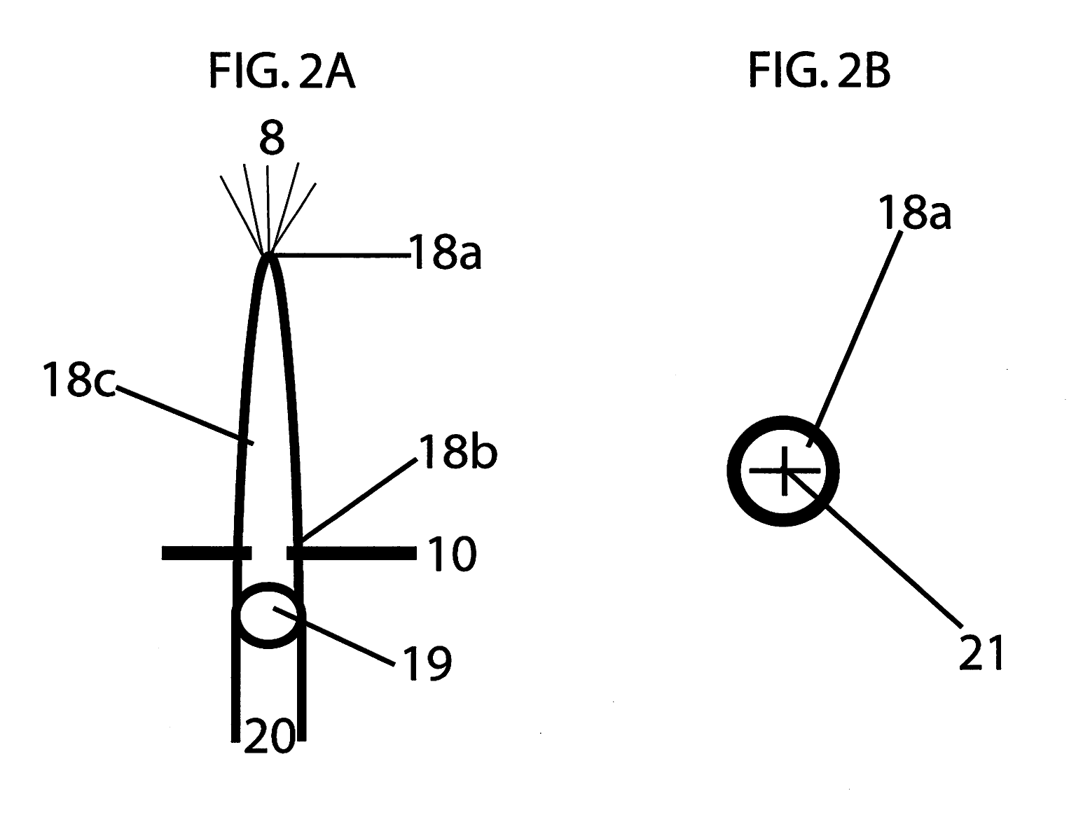

The nozzle 18 is a relatively slender cylindrical form made of synthetic resin having a condensed leading end as shown in FIG. 2A.

A nozzle neck 18c formed in a taper tube small in diameter at the leading end 18a side and larger in diameter at the base side 18b and stopped in the cooler housing 10 are bonded using means for bonding to be employed (adhering, clipping or taping with double sided tape). Accordingly, only by piercing pores in the cooler housing 10, the nozzle 18 can be mounted instantly and securely. The leading end of the nozzle 18a has piercings 21 to allow for the solvent to mist at the end of the nozzle.

In FIG. 2B, an embodiment of the nozzle is depicted, showing a cross-shaped aperture for misting the applied liquid. The size of the aperture is enlarged here to show the detail; the actual aperture is much smaller. Depending upon the viscosity and type of liquid used, other apertures may be useful, such as multiple separated cylindrical openings. The nozzle base 18b is connected to check valve 19 and then to the leading end of the rubber hose 20 which is adhered and fixed to the check valve 19 and to the nozzle 18 by elastic force. Check valve 19 allows fluid to flow in only one direction, so that the electric pump does not go dry in between activations. This decreases the time the system must be activated in order to produce the desired amount of aerosol mist, even if a long period of time occurs between subsequent activations.

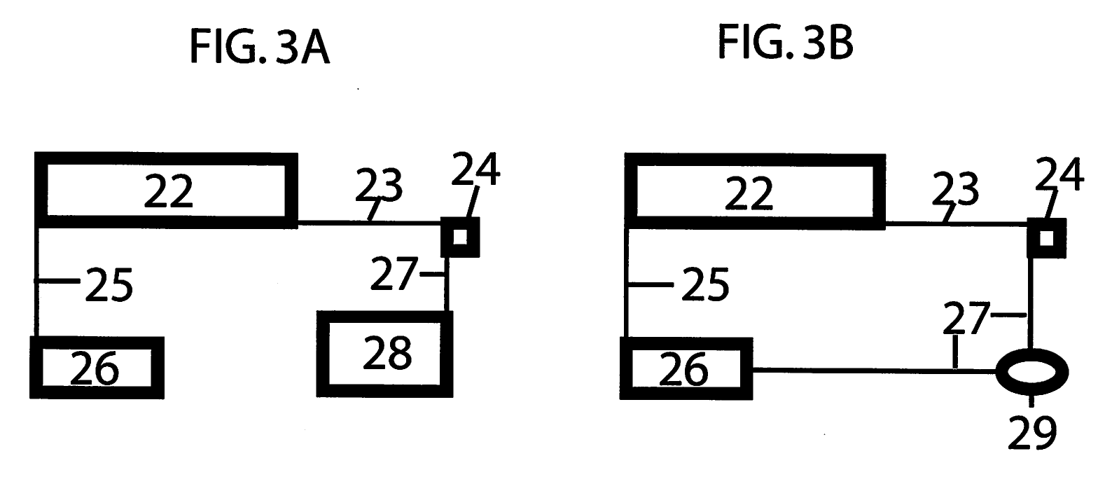

In FIG. 3A, an example connection diagram is shown in a vehicle that incorporates a fuse panel. The switch 24 is connected through wire 27 to vehicle fuse panel 28 and then connected through wire 23 to electric pump 22. The electric circuit for electric pump 22 is completed to ground through wire 25 which is connected to the ground terminal of vehicle battery 26.

FIG. 3B shows an example connection diagram in a vehicle where a spare fuse on a fuse panel is not available. The wiring for the switch 24 is connected to an inline fuse 29 and is directly applied to the battery 26. Electric pump 22 is connected to the electrical system through switch 24 which itself is connected by wire 27 to the vehicle battery 26 through inline fuse 29.

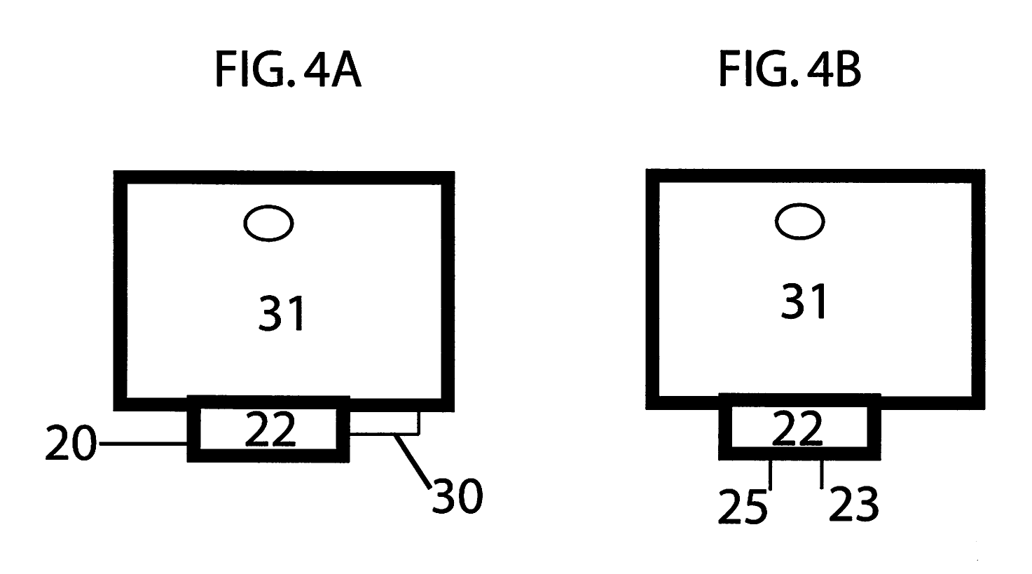

FIG. 4A shows the liquid connections of a preferred embodiment of the invention. One end of rubber hose 20 is connected to the electric pump 22. The liquid input of electric pump 22 is attached to refillable container 31 through supply hose 30, which is connected on the other side to refillable container 31 to permit liquid to flow therebetween. Refillable container 31 is mounted directly to any part of the vehicle that would be able to hold and sustain the weight of the container without affecting the stability or function of the other parts of the vehicle and would be secured using the proper means (adhering, bolting or clipping).

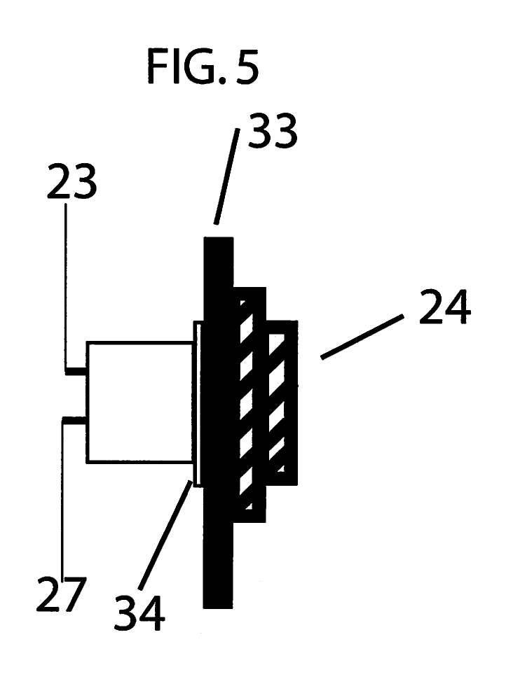

It can be observed that the only visible part of the apparatus in the passenger compartment of the vehicle is the switch 24 that will be located somewhere accessible to an occupant of the passenger compartment. As shown in FIG. 5, whether connection is made through the fuse panel as depicted in FIG. 3A or through an inline fuse as depicted in FIG. 3B, switch 24 is affixed to any accessible place in the interior of the vehicle by piercing the surface of the interior 33 to permit wiring to pass through, then held in place with a washer 34 or by any other proper means (adhering, bolting, clipping or taping with double sided adhesive tape).

Herein, embodiments of the liquid employed in the apparatus include but are not limited to a cleaning solution, an odor eliminating solution, a disinfectant, antibacterial, fungicide, deodorant, or fragrance, which may be used either alone or in mixture. The desired liquid is placed into the refillable container, and liquids may be replaced or exchanged at the desire of the user.

The action of the accessory structure for vehicle air-handling system thus constituted is described below.

When the user requests to use the apparatus and deploy the liquid, switch 24 is depressed sending an electric current through electric pump 22. Electric pump 22, thusly activated, then drives the liquid through hose 20 to nozzle 18 into cooler housing which mists the liquid into liquid spray 8.

The air flow from the blower then carries the liquid in aerosol form through the evaporator, then through the vents into the interior of the vehicle.

The applications of this apparatus are therefore not limited to vehicles with air-conditioning only; it may be used with any vehicle air-handling system with the only restriction being that there is an air flow source. When the vehicle is moving, for example, air flow can be created through the vents into the passenger compartment which can carry the misted liquid. Moreover the components of this invention may be made of any substance that would not limit the productivity of the invention.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An apparatus for dispersing a liquid in aerosol form into the air-handling system of a vehicle comprising:
a) a container to hold liquid;
b) an electric pump connected to said container to allow said liquid to flow from said container to said pump;
c) a check valve connected to said electric pump to allow fluid flow in only one direction when said electric pump is activated; and
d) a nozzle connected to said check valve to allow said liquid to flow from said pump to said nozzle through said check valve, said nozzle pointing into said air-handling system of a vehicle;
said electric pump being activated electrically in response to actions from the user to pump said liquid from said container through said check valve to said nozzle to spray said liquid in aerosol form into said air-handling system of a vehicle.

2. An apparatus for dispersing a liquid in aerosol form into the air-handling system of a vehicle comprising:
a) a container to hold liquid;
b) an electric pump connected to said container to allow said liquid to flow from said container to said pump;
c) a check valve connected to said electric pump to allow fluid flow in only one direction when said electric pump is activated;
d) a nozzle connected to said check valve to allow said liquid to flow from said pump to said nozzle through said check valve, said nozzle terminating into the air-handling system of a vehicle; and
e) a switch connected to said electric pump to turn on said electric pump to cause said liquid to be conducted from said container through said electric pump into said check valve and said nozzle to cause said liquid to spray from said nozzle in aerosol form into said air circulation system of said vehicle.

3. In an air-handling system for a vehicle, the improvement comprising:
a) a container to hold liquid;
b) an electric pump connected to said container to allow said liquid to flow from said container to said pump;
c) a check valve connected to said electric pump to allow said liquid to flow in only one direction; namely, away from said electric pump;
c) a nozzle connected to said check valve to allow said liquid to flow from said pump to said nozzle, said nozzle inserted into said air-handling system for a vehicle; and
d) a switch connected to said electric pump to turn on said electric pump to cause said liquid to be conducted from said container through said electric pump into said nozzle to cause said liquid to spray in aerosol form from said nozzle into said air-handling system for a vehicle.

4. The apparatus in claim 1, wherein said liquid contains a fragrance.

5. The apparatus in claim 1, wherein said liquid contains a deodorant.

6. The apparatus in claim 2, wherein said liquid contains a fragrance.

7. The apparatus in claim 2, wherein said liquid contains a deodorant.

8. The apparatus in claim 3, wherein said liquid contains a fragrance.

9. The apparatus in claim 3, wherein said liquid contains a deodorant.

10. The apparatus in claim 1, wherein said liquid contains a disinfectant.

11. The apparatus in claim 2, wherein said liquid contains a disinfectant.

12. The apparatus in claim 3, wherein said liquid contains a disinfectant.
